(19) United States
(12) Patent Application Publication
(10) Pub. No.: US 2015/0248676 A1
(43) Pub. Date: Sep. 3, 2015

(54) TOUCHLESS SIGNATURE

(71) Applicants: Sathish Vaidyanathan, Chennai (IN); Prasanna Annamalai, Chennai (IN); Tushar Raibhandare, Chennai (IN)

(72) Inventors: Sathish Vaidyanathan, Chennai (IN); Prasanna Annamalai, Chennai (IN); Tushar Raibhandare, Chennai (IN)

(21) Appl. No.: 14/194,578

(22) Filed: Feb. 28, 2014

(51) Int. Cl. G06Q 20/40; G06Q 20/32

(52) U.S. Cl. CPC G06Q 20/40145; G06Q 20/3226

(57) ABSTRACT

Methods and systems for facilitating secure payments are described. A user signature is shared with a merchant without providing an actual signature to the merchant. A signature code encoded with a user's handwritten signature is generated and presented to a merchant upon request for signature. The signature code is scanned by the merchant, and data in the signature code is transmitted to a service provider. The service provider receives the data and retrieves the signature. The signature code can be used at a retail location during checkout, during delivery of merchandise, or for acknowledgement of mail delivery.

### BACKGROUND

1. Field of the Invention

The present invention generally relates to conducting secure financial transactions.

2. Related Art

When paying for items, consumers typically provide a merchant with a credit card, the credit card is swiped by the merchant, and the consumer signs a credit card slip or a merchant-owned signature-capture device at the cash register. Unfortunately, dishonest merchants can use the consumer's signature to commit fraud by forging the consumer's signature. In some instances, when the consumer signs on the merchant-owned device such as a touch-screen device with his or her finger, the signature can be misused to commit fingerprint fraud. Thus, there is a need for systems and methods that allow a consumer to provide a signature to the merchant, without touching a merchant device or physically signing a document.

### BRIEF DESCRIPTION OF THE FIGURES

FIG. 1 is a block diagram illustrating a system for facilitating secure payments according to an embodiment of the present disclosure;

FIG. 2 is a flowchart showing a method for facilitating secure payments according to an embodiment of the present disclosure; and

FIG. 3 is a block diagram of a system for implementing one or more components in FIG. 1 according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The systems and methods described herein facilitate payment to a merchant using a signature code that is generated by a service provider, such as PayPal®, Inc. of San Jose, Calif. The signature code can be used at a retail location during checkout, or during delivery of merchandise or service. The signature code, e.g., a barcode, a Quick Response (QR) code, or other computer-readable code, is encoded with a user's handwritten signature and presented to a merchant upon request for signature. Barcodes and QR codes can be encoded with information, and this information can be gleaned by reading the bar code or QR code with a scanner. The signature code is scanned by the merchant to obtain the signature. In this way, a user need not physically sign a receipt or touch a merchant device.

In various embodiments, the signature codes include a QR code that is used to encode a randomly generated string of letters and numbers (e.g., 116d243b2f598to0p) that corresponds to the image of the user's signature. When a merchant asks for a user's signature after a transaction, the user can request generation of a QR code from the user-owned device. Upon receiving the request, the service provider retrieves the image, generates a random string that corresponds to the user signature, associates it with an expiry timestamp, and sends it back to the user as an expirable QR code. The merchant then scans the user's QR code, and submits the data (the random string) represented as the QR code back to the service provider. The service provider validates the expiration date of the QR code and converts the QR code back into a signature before processing the transaction.

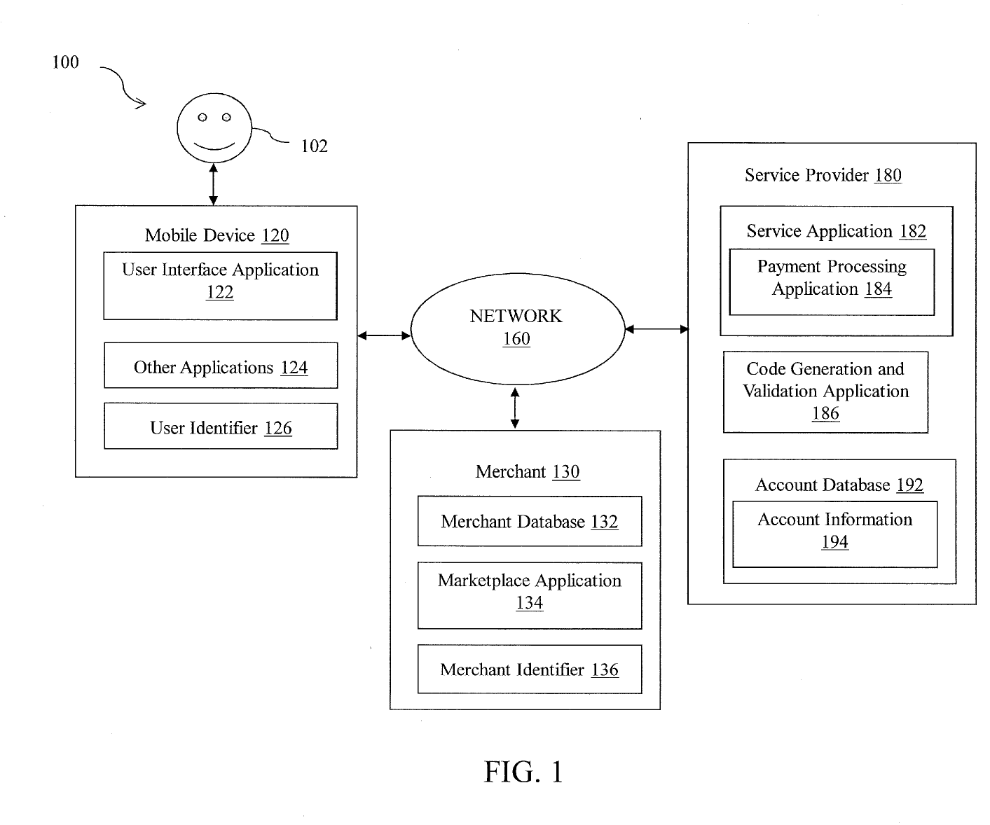

FIG. 1 shows one embodiment of a block diagram of a network-based system 100 adapted to facilitate payment using a mobile device 120 over a network 160. As shown, system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

As shown in FIG. 1, the system 100 includes a mobile device 120 (e.g., a smartphone), one or more merchant servers or devices 130 (e.g., network server devices), and at least one service provider server or device 180 (e.g., network server device) in communication over the network 160. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet. As such, in various embodiments, the mobile device 120, merchant servers or devices 130, and service provider server or device 180 may be associated with a particular link (e.g., a link, such as a URL (Uniform Resource Locator) to an IP (Internet Protocol) address).

The mobile device 120, in one embodiment, may be utilized by the user 102 to interact with the service provider server 180 over the network 160. For example, the user 102 may conduct financial transactions (e.g., account transfers) with the service provider server 180 via the mobile device 120. The mobile device 120, in various embodiments, may be implemented using any appropriate combination of hardware and/or software configured for wired and/or wireless communication over the network 160. The mobile device 120, in one embodiment, may be utilized by the user 102 to interact with the service provider server 180 over the network 160. For example, the user 102 may conduct financial transactions (e.g., account transfers) with the service provider server 180 via the mobile device 120. In various implementations, the mobile device 120 may include at least one of a wireless cellular phone, personal digital assistant (PDA), satellite phone, etc.

The mobile device 120, in one embodiment, includes a user interface application 122, which may be utilized by the user 102 to conduct transactions (e.g., shopping, purchasing, bidding, etc.) with the merchant server or device 130 or with the service provider server 180 over the network 160. In one aspect, purchase expenses may be directly and/or automatically debited from an account related to the user 102 via the user interface application 122.

In one implementation, the user interface application 122 comprises a software program, such as a graphical user interface (GUI), executable by a processor that is configured to interface and communicate with the service provider server 180 via the network 160. In another implementation, the user interface application 122 comprises a browser module that provides a network interface to browse information available over the network 160. For example, the user interface application 122 may be implemented, in part, as a web browser to view information available over the network 160.

In an example, the user 102 is able to access merchant websites via the one or more merchant servers 130 to view and select items for purchase, and the user 102 is able to purchase items from the one or more merchant servers 130 via the service provider server 180. Accordingly, in one or more embodiments, the user 102 may conduct transactions (e.g., purchase and provide payment for one or more items) from the one or more merchant servers 130 via the service provider server 180.

The mobile device 120, in various embodiments, may include other applications 124 as may be desired in one or more embodiments of the present disclosure to provide additional features available to user 102. In one example, such other applications 124 may include security applications for implementing client-side security features, programmatic client applications for interfacing with appropriate application programming interfaces (APIs) over the network 160, and/or various other types of generally known programs and/or software applications. In still other examples, the other applications 124 may interface with the user interface application 122 for improved efficiency and convenience.

In various implementations, a user profile may be created using data and information obtained from cell phone activity over the network 160. Cell phone activity transactions may be used by the service provider server 180 to create at least one user profile for the user 102 based on activity from the mobile device 120 (e.g., cell phone). The user profile may be updated with each financial and/or information transaction (e.g., payment transaction, purchase transaction, etc.) achieved through use of the mobile device 120. In various aspects, this may include the type of transaction and/or the location information from the mobile device 120. As such, the profile may be used for recognizing patterns of potential fraud, setting transaction limits on the user, etc.

The mobile device 120, in one embodiment, may include at least one user identifier 126, which may be implemented, for example, as operating system registry entries, cookies associated with the user interface application 122, identifiers associated with hardware of the mobile device 120, or various other appropriate identifiers. The user identifier 126 may include one or more attributes related to the user 102, such as personal information related to the user 102 (e.g., one or more user names, passwords, photograph images, biometric IDs, addresses, phone numbers, social security number, etc.) and banking information and/or funding sources (e.g., one or more banking institutions, credit card issuers, user account numbers, security data and information, etc.). In various implementations, the user identifier 126 may be passed with a user login request to the service provider server 180 via the network 160, and the user identifier 126 may be used by the service provider server 180 to associate the user 102 with a particular user account maintained by the service provider server 180.

In various implementations, the user 102 is able to input data and information into an input component (e.g., a keyboard) of the mobile device 120 to provide user information with a transaction request, such as a fund transfer request. The user information may include user identification information.

The one or more merchant servers 130, in various embodiments, may be maintained by one or more business entities (or in some cases, by a partner of a business entity that processes transactions on behalf of business entities). Examples of businesses entities include merchant sites, resource information sites, utility sites, real estate management sites, social networking sites, etc., which offer various items for purchase and payment. In some embodiments, business entities may need registration of the user identity information as part of offering the items to the user 102 over the network 160. As such, each of the one or more merchant servers 130 may include a merchant database 132 for identifying available items, which may be made available to the mobile device 120 for viewing and purchase by the user 102. In one or more embodiments, user 102 may complete a transaction such as purchasing the items via service provider server 180.

Each of the merchant servers 130, in one embodiment, may include a marketplace application 134, which may be configured to provide information over the network 160 to the user interface application 122 of the mobile device 120. For example, user 102 may interact with the marketplace application 134 through the user interface application 122 over the network 160 to search and view various items available for purchase in the merchant database 132.

Each of the merchant servers 130, in one embodiment, may include at least one merchant identifier 136, which may be included as part of the one or more items made available for purchase so that, e.g., particular items are associated with particular merchants. In one implementation, the merchant identifier 136 may include one or more attributes and/or parameters related to the merchant, such as business and banking information. In various embodiments, user 102 may conduct transactions (e.g., searching, selection, monitoring, purchasing, and/or providing payment for items) with each merchant server 130 via the service provider server 180 over the network 160.

A merchant website may also communicate (for example, using merchant server 130) with the service provider through service provider server 180 over network 160. For example, the merchant website may communicate with the service provider in the course of various services offered by the service provider to merchant website, such as payment intermediary between customers of the merchant website and the merchant website itself. For example, the merchant website may use an application programming interface (API) that allows it to offer sale of goods in which customers are allowed to make payment through the service provider, while user 102 may have an account with the service provider that allows user 102 to use the service provider for making payments to merchants that allow use of authentication, authorization, and payment services of service provider as a payment intermediary. The merchant website may also have an account with the service provider.

The service provider server 180, in one embodiment, may be maintained by a transaction processing entity or an online service provider, which may provide processing for financial transactions and/or information transactions between the user 102 and one or more of the merchant servers 130. As such, the service provider server 180 includes a service application 182, which may be adapted to interact with the mobile device 120 and/or each merchant server 130 over the network 160 to facilitate the searching, selection, purchase, and/or payment of items by the user 102 from one or more of the merchant servers 130. In one example, the service provider server 180 may be provided by PayPal®, Inc., eBay® of San Jose, Calif., USA, and/or one or more financial institutions or a respective intermediary that may provide multiple point of sale devices at various locations to facilitate transaction routings between merchants and, for example, financial institutions.

The service application 182, in one embodiment, utilizes a payment processing application 184 to process purchases and/or payments for financial transactions between the user 102 and each of the merchant servers 130. In one implementation, the payment processing application 184 assists with resolving financial transactions through validation, delivery, and settlement. As such, the service application 182 in conjunction with the payment processing module 184 settles indebtedness between the user 102 and each of the merchants 130, wherein accounts may be directly and/or automatically debited and/or credited of monetary funds in a manner as accepted by the banking industry.

The service provider server 180, in one embodiment, may be configured to maintain one or more user accounts and merchant accounts in an account database 192, each of which may include account information 194 associated with one or more individual users (e.g., user 102) and merchants (e.g., one or more merchants associated with merchant servers 130). For example, account information 194 may include private financial information of user 102 and each merchant associated with the one or more merchant servers 130, such as one or more account numbers, passwords, credit card information, banking information, or other types of financial information, which may be used to facilitate financial transactions between user 102, and the one or more merchants associated with the merchant servers 130. In various aspects, the methods and systems described herein may be modified to accommodate users and/or merchants that may or may not be associated with at least one existing user account and/or merchant account, respectively.

In one implementation, the user 102 may have identity attributes stored with the service provider server 180, and user 102 may have credentials to authenticate or verify identity with the service provider server 180. User attributes may include personal information, banking information and/or funding sources. In various aspects, the user attributes may be passed to the service provider server 180 as part of a login, search, selection, purchase, and/or payment request, and the user attributes may be utilized by the service provider server 180 to associate user 102 with one or more particular user accounts maintained by the service provider server 180.

In various embodiments, the service provider server 180 also includes code generation and validation application 186. The application 186 generates a unique signature code (e.g., a QR code or barcode) associated with the user 102's signature in response to a request from user 102. The signature code is presented on the screen of mobile device 120, and a merchant can scan the signature code. The application 186 also validates the signature code to determine if it has expired.

In some embodiments, the application 186 also receives an image of the user's handwritten signature and converts it into a binary value. The signature can then be stored in a binary format. When the user 102 requests that a signature code corresponding to the user signature be created, the application 186 generates a random string that corresponds to the user signature, associates it with an expiry timestamp, and sends the signature code (e.g., QR code) to the user 102.

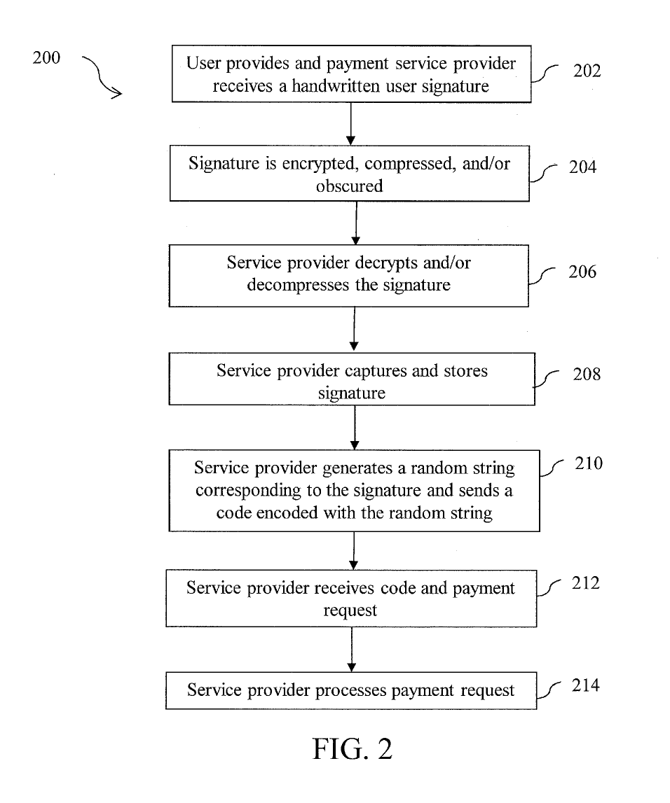

Referring now to FIG. 2, a flowchart of a method 200 for facilitating secure payments is illustrated according to an embodiment of the present disclosure. In various embodiments, the user 102 registers with a service provider, which runs a mobile application. Registration may include signing up for the service and agreeing to any terms required by the service provider, such as through a user device. In one embodiment, the user device is a mobile computing device, such as a smart phone, a PC, or a computing tablet. In other embodiments, registration may be done completely through the user device, partially through the user device, or without using the user device, such as through a phone call or in-person visit to a representative of the payment service provider.

The user may be requested to provider specific information for registration, such as, but not limited to, a name, address, phone number, email address, picture, a user name for the account, and a password or PIN for the account. The type of information may depend on whether the user already has an account with the service provider. Requested information may be entered through the user device or other means, including voice or manual key entry. Once all the requested information is received and confirmed, the service provider may create an account for the user.

At step 202, the user 102 provides and the service provider server 180 receives the user 102's handwritten signature. Advantageously, the user 102 provides the signature once, and need not provide it for every transaction. In one embodiment, the user 102 signs into the mobile application and draws a signature using a touch-screen device. The signature is associated with the user 102's account.

At step 204, the image of the signature is encrypted, compressed, and/or obscured by the mobile application to protect the security of the signature. Data encryption transforms the image of the signature into a form that is non-readable to unauthorized parties. Data compression reduces the size of the image to reduce the time required to transmit the image across a network. Obscuring of the data hides or blurs sensitive data. The encrypted, compressed, and/or obscured image is then transmitted to the service provider, and the image is uploaded to the payment service provider server 180.

At step 206, the service provider decrypts and/or decompresses the image. The image can be decrypted, for example, by using a key and transforming the image back to its original version. Encryption and decryption are well known in the art and thus are not described in detail herein.

At step 208, the service provider captures and stores the signature in any one of the popular formats like Joint Photographic Experts Group (JPEG), Portable Network Graphic (PNG), or Scalable Vector Graphics (SVG) with encryption. The stored image is associated with a particular user based on the user's profile attributes (e.g., account creation timestamp, account-identifier, email ID, etc.).

In the present example, the service provider associates the signature with user 102 and stores the signature as a binary format. Using a binary format for the signature typically provides faster and more flexible access to the signature and takes up less memory.

When user 102 makes a purchase or receives a delivery, a merchant asks for the user 102's signature after the transaction. Instead of providing a physical signature, user 102 may decide to provide a code corresponding to the signature instead and request that the service provider server 180 generate a code.

At step 210, the service provider generates a random string that corresponds to the user signature and sends the signature code (e.g., QR code) encoded with the random string. The signature code may be sent to the user's mobile device in any suitable way, including by email, phone, text, or push notification. The signature code can be stored on the mobile device 120, stored on the service provider server 180, or generated each time user 102 requests.

In some embodiments, the service provider server associates the random string with an expiry timestamp. In various embodiments, the signature code is a time-sensitive, expirable QR code. In these embodiments, the QR code is non-functional after a few minutes of generation, to prevent someone from misusing it at a later time.

In these embodiments, the user 102 has a limited amount of time to present the signature code to the merchant. If the user 102 does not provide the signature code within a given time period, the service provider may operate to cancel use of the signature code. The signature code may expire after a user defined time limit. Typically, expiry time is 5 minutes. The code may be valid for a set time, such as one minute or 3 minutes, within which it needs to be submitted to the service provider server 180 for validation in relation to a transaction. In certain embodiments, the code may be time-limited to expire automatically. The time limit should be set low enough to make it difficult for someone to capture the code, but high enough not to expire too fast for normal transactions. In some embodiments, the time limit may be user configurable and/or may vary depending on recipient or type of transaction.

The user 102 presents the screen showing the signature code to the merchant. The merchant scans or otherwise reads the signature code displayed on the mobile device 120 and submits the data inside the signature code back to the service provider server 180. The scanning functionality may be provided by a mobile application, or may be performed by a smart device or barcode or QR code scanner. The data includes a random string which uniquely identifies the signature, profile attributes of the user, and the timestamp. In one embodiment, the data is presented to the merchant as a hyperlink.

At step 212, the service provider server 180 receives the signature code and a request for payment from the merchant. The service provider validates the expiry of the signature code, and retrieves the signature corresponding to the signature code.

The service provider then passes the signature to, for example, a credit card company or any other entity that stores signatures as proof (e.g., mail or package delivery companies, banks, merchants, etc.), for safekeeping, along with a record of the card details and the amount to be paid. The user 102 indicates consent to pay by providing the signature. If there is ever a dispute or challenge about the charge, the credit card company can show that the user 102 signed for the purchase. The credit card company can also compare the signature provided by the service provider with the signature they have on file to authenticate the user 102. The credit card company verifies that the account is valid and that there is enough credit to cover the transaction.

Similarly, in the case of providing a signature on delivery of a package, the delivery company can store the signature in case there is a disagreement about whether the package was delivered. A signature proves that the package was delivered and received.

In another example, user 102 issues a check online by providing the check details along with the signature code that can be scanned by a website's application, such as Flash. The service provider passes the signature that corresponds to the signature code to the bank that issued the check so that the bank has evidence that the user 102 intended the payment on the check.

When the credit card company authorizes the transaction, at step 214, the service provider server 180 approves and processes the payment request. After processing, the service provider may then transmit a notification to the user 102 and/or the merchant. The handwritten signature is stored in binary format on, for example, the service provider server 180 so that it can be used the next time the user 102 requests a signature code.

Advantageously, because the methods and systems described herein avoid the case of a user signing on a merchant device or touch phone, the present disclosure can prevent signature forgery and prevent user's fingerprints from being stolen by fraudulent merchants. The methods are cost-effective and can be used at banking institutions or point of sale (POS) terminals. The methods described herein can be used in a variety of cases. For example, they can be used in association with credit cards, debit cards, signatures at POS terminals, paycode+signature combinations, and checks. The methods are also useful in cases where the merchant accepts cash on delivery or card on delivery. The present disclosure is also useful in mail delivery signature cases, where a user signs an acknowledgement. The methods and systems described herein make the consumer payment experience more convenient and allow the consumer to use their mobile device to build a secure experience.

### Example

A particular example will now be described. Tim buys a pizza from a local pizza parlor and asks for delivery. Mike, the pizza delivery person, shows up at Tim's house with a PayPal Here™ device. Mike swipes Tim's credit card and asks for Tim's signature on his touch phone.

Instead of signing on the phone, Tim decides to provide a QR code corresponding to his signature instead. Tim opens his PayPal® application and requests that a signature code be generated that includes his signature. PayPal® retrieves his signature from a database and generates a random string corresponding to Tim's signature. The random string is embedded in a QR code that is sent to Tim and displayed on his smartphone. Tim flashes his smartphone with the displayed QR code to Mike. Mike scans the QR code with his device, and the scanned value is sent back to PayPal® for further processing. PayPal® retrieves Tim's signature and sends the signature to the credit card company so that the credit card company has proof that Tim agreed to pay for the pizza.

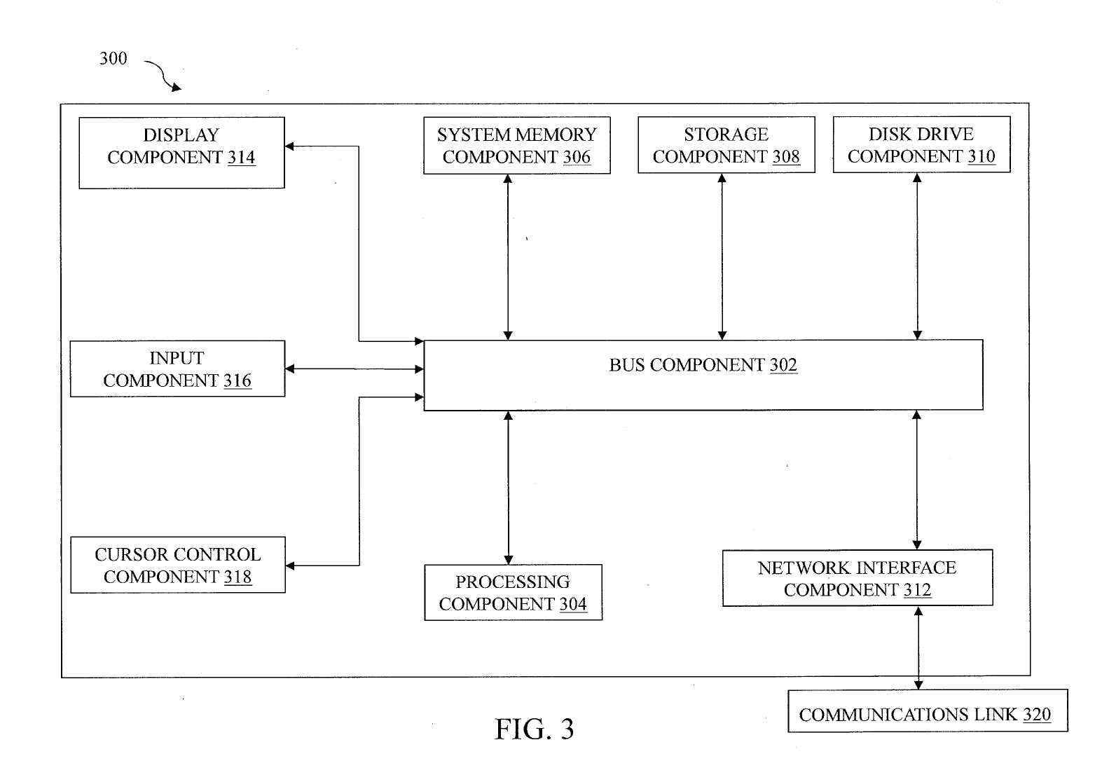

Referring now to FIG. 3, a block diagram of a system 300 is illustrated suitable for implementing embodiments of the present disclosure, including mobile device 120, one or more merchant servers or devices 130, and service provider server or device 180. System 300, such as part of a cell phone, a tablet, a personal computer and/or a network server, includes a bus 302 or other communication mechanism for communicating information, which interconnects subsystems and components, including one or more of a processing component 304 (e.g., processor, micro-controller, digital signal processor (DSP), etc.), a system memory component 306 (e.g., RAM), a static storage component 308 (e.g., ROM), a disk drive component 310, a network interface component 312, a display component 314 (or alternatively, an interface to an external display), an input component 316 (e.g., keypad or keyboard), and a cursor control component 318 (e.g., a mouse pad).

In some embodiments, system 300 includes an image acquisition component, for example, a camera (e.g., a digital camera or video camera). The image acquisition component may be any device component capable of capturing images of objects and/or reading codes (e.g., barcodes and QR codes).

In accordance with embodiments of the present disclosure, system 300 performs specific operations by processor 304 executing one or more sequences of one or more instructions contained in system memory component 306. Such instructions may be read into system memory component 306 from another computer readable medium, such as static storage component 308. These may include instructions to process financial transactions, make payments, etc. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 304 for execution. Such a medium may take many forms, including but not limited to, non-volatile media, volatile media, and transmission media. In various implementations, volatile media includes dynamic memory, such as system memory component 306, and transmission media includes coaxial cables, copper wire, and fiber optics, including wires that comprise bus 302. Memory may be used to store visual representations of the different options for searching, auto-synchronizing, making payments or conducting financial transactions. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 300. In various other embodiments, a plurality of systems 300 coupled by communication link 320 (e.g., network 160 of FIG. 1, LAN, WLAN, PTSN, or various other wired or wireless networks) may perform instruction sequences to practice the disclosure in coordination with one another. Computer system 300 may transmit and receive messages, data, information and instructions, including one or more programs (i.e., application code) through communication link 320 and communication interface 312. Received program code may be executed by processor 304 as received and/or stored in disk drive component 310 or some other non-volatile storage component for execution.

In view of the present disclosure, it will be appreciated that various methods and systems have been described according to one or more embodiments for facilitating secure payments.

Although various components and steps have been described herein as being associated with mobile device 120, merchant server 130, and service provider server 180 of FIG. 1, it is contemplated that the various aspects of such servers illustrated in FIG. 1 may be distributed among a plurality of servers, devices, and/or other entities.

Where applicable, various embodiments provided by the present disclosure may be implemented using hardware, software, or combinations of hardware and software. Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system, comprising:
a memory device storing user signature information; and
one or more processors in communication with the memory device and operable to:
receive a request for a signature code from a user;
generate a signature code corresponding to a handwritten signature of the user;
transmit the signature code to a mobile device associated with the user;
receive data in the signature code from a merchant; and
retrieve the handwritten signature corresponding to the signature code.

2. The system of claim 1, wherein the signature code comprises a barcode, a quick response (QR) code, or a combination thereof.

3. The system of claim 1, wherein the one or more processors is further operable to associate the signature code with an expiry timestamp.

4. The system of claim 3, wherein the one or more processors is further operable to validate expiry of the signature code.

5. The system of claim 1, wherein the data comprises a random string that identifies the handwritten signature, profile attributes of the user, and an expiry timestamp.

6. The system of claim 1, wherein the one or more processors is further operable to transmit the handwritten signature to an entity that stores the handwritten signature.

7. The system of claim 1, wherein the one or more processors is further operable to store the handwritten signature in a binary format.

8. The system of claim 1, wherein the data is received from the merchant when the merchant scans the signature code using another mobile device.

9. A method for facilitating secure payments, comprising:
receiving, by one or more hardware processors of a service provider, a request for a signature code from a user;
generating, by the one or more hardware processors, a signature code corresponding to a handwritten signature of the user;
transmitting, by the one or more hardware processors, the signature code to a mobile device associated with the user;
receiving, by the one or more hardware processors, data in the signature code from a merchant; and
retrieving, by one or more hardware processors, the handwritten signature corresponding to the signature code.

10. The method of claim 9, wherein the signature code comprises a barcode, a quick response (QR) code, or a combination thereof.

11. The method of claim 9, further comprising associating the signature code with an expiry timestamp.

12. The method of claim 11, further comprising validating expiry of the signature code.

13. The method of claim 9, wherein the data comprises a random string that identifies the handwritten signature, profile attributes of the user, and an expiry timestamp.

14. The method of claim 13, further comprising transmitting the handwritten signature to an entity that stores the handwritten signature.

15. The method of claim 9, further comprising storing the handwritten signature in a binary format.

16. A non-transitory machine-readable medium comprising a plurality of machine-readable instructions which, when executed by one or more processors, are adapted to cause the one or more processors to perform a method comprising:
receiving a request for a signature code from a user;
generating a signature code corresponding to a handwritten signature of the user;
transmitting the signature code to a mobile device associated with the user;
receiving data in the signature code from a merchant; and
retrieving the handwritten signature corresponding to the signature code.

17. The non-transitory machine-readable medium of claim 16, wherein the method further comprises associating the signature code with an expiry timestamp.

18. The non-transitory machine-readable medium of claim 17, wherein the method further comprises validating expiry of the expiry timestamp.

19. The non-transitory machine-readable medium of claim 16, wherein the data comprises a random string that identifies the handwritten signature, profile attributes of the user, and an expiry timestamp.

20. The non-transitory machine-readable medium of claim 16, wherein the method further comprises transmitting the handwritten signature to an entity that stores the handwritten signature.
